(19) United States
(12) Patent Application Publication
(10) Pub. No.: US 2018/0293576 A1
(43) Pub. Date: Oct. 11, 2018

(54) SYSTEM FOR CUSTOM CURRENCY TRANSACTION BASED ON BLOCKCHAIN AND OPERATING METHOD THEREOF

(71) Applicant: SAMSUNG SDS CO., LTD., Seoul (KR)

(72) Inventors: Kwang Woo SONG, Seoul (KR); Jae Ho KIM, Seoul (KR); Mun Seok YANG, Seoul (KR); Dae Hyun PARK, Seoul (KR)

(73) Assignee: SAMSUNG SDS CO., LTD., Seoul (KR)

(21) Appl. No.: 15/933,546

(22) Filed: Mar. 23, 2018

(30) Foreign Application Priority Data
Apr. 5, 2017 (KR) 10-2017-0044428
Sep. 25, 2017 (KR) 10-2017-0123554

(51) Int. Cl. G06Q 20/40; G06Q 20/06; G06Q 20/36; H04L 9/06

(52) U.S. Cl. CPC G06Q 20/401; G06Q 20/065; H04L 67/104; H04L 9/0637; G06Q 20/36

(57) ABSTRACT

Provided are a blockchain-based custom currency transaction system comprising a plurality of blockchain nodes configured to establish a peer-to-peer (P2P)-based blockchain network, distribute and manage blockchain data in which a plurality of blocks are connected in a chain form, and record, using the blockchain data, transaction data of a custom currency defined based on a cryptocurrency and a service providing server configured to interwork with the blockchain network and provide a transaction service for the custom currency, wherein the transaction data comprises first information about a first currency amount of the custom currency to be transacted and second information about a second currency amount of the cryptocurrency to be transacted.

This application claims priority from Korean Patent Application No. 10-2017-0044428 filed on Apr. 5, 2017 and No. 10-2017-0123554 filed on Sep. 25, 2017 in the Korean Intellectual Property Office, the disclosure of which is incorporated herein by reference in its entirety.

### BACKGROUND

### 1. Field of the Disclosure

The present disclosure relates to a system for a custom currency transaction based on a blockchain and an operating method thereof, and more particularly, to a transaction system for providing a safe transaction service with regard to a custom currency defined based on a cryptocurrency of a blockchain and a method of operating the same.

### 2. Description of the Related Art

A blockchain refers to data management technology, in which continuously growing data is recorded in certain units of block and nodes of a peer-to-peer (P2P) network managing the blocks in a chain-form data structure, or refers to data itself of the chain-form data structure. In this case, blockchain data of the chain-form data structure is managed in the form of a distributed ledger at each individual node, without a central system.

Each individual blockchain node of a blockchain network manages blocks in such a data structure, as shown in FIG. 1. Here, each block is recorded with a hash value of a previous block, so that the previous block can be referred to by the hash value. Therefore, as more blocks are added, it becomes difficult to forge transaction data recorded in the block, and the transaction data recorded in each block is improved in reliability.

Today, with the merits of the foregoing blockchain technology, there have been proposed various systems for providing a transaction service of a cryptocurrency issued and circulated through a blockchain. As a representative cryptocurrency transaction system, there is a Bitcoin system.

The Bitcoin system performs unspent transaction output (UTXO) verification according to transactions in order to prevent a double spending problem and provide a safe transaction service. For example, when transaction data 10 is received as shown in FIG. 2, each individual blockchain node performs verifications of whether information about an owner of a UTXO recorded in an input part 11 matches a payer, whether the sum of UTXO recorded in the input part 11 is greater than the sum of UTXO recorded in an output part 13 or 15, and the like. Through this, users who use the Bitcoin system are assured of stability and reliability in transactions.

Meanwhile, an open asset protocol is one of representative derivative technologies for increasing utility of the cryptocurrency to be transacted through a blockchain. As shown in FIG. 3, the open asset protocol is provided in an overlay layer 23 of a blockchain protocol layer 21, and is an asset issue technology that defines and issues a custom currency (or a custom asset) based on a cryptocurrency (or a native asset) issued through the blockchain.

When the open asset protocol is applied to a Bitcoin system, a bitcoin transaction 30 can be directly used in the custom currency transactions (e.g., a point, a stock, etc.), as shown in FIG. 4.

However, the custom currency defined and issued through the open asset protocol is made in the form of an overlay of the cryptocurrency, and the custom currency transactions are not secured even though the UTXO verification is performed. Therefore, to provide a secured transaction service, a custom currency transaction system is required to have a separate mechanism for performing transaction validation with regard to double spending of a custom currency or the like, in addition to the UTXO verification performed in the blockchain itself. For example, there is a need for providing a separate transaction validation application for verifying the transaction validity of a custom currency.

However, the addition of the separate transaction verification application to a custom currency transaction system is an approach that does not utilize the key features of blockchain technology for its original transaction security purpose. Further, a new transaction verification application is required whenever a custom currency is newly defined, and therefore there is a considerable limitation in expanding a custom currency transaction service based on a blockchain.

### SUMMARY

Aspects of the present disclosure provide a blockchain-based custom currency transaction system that provides a secure transaction service with regard to a custom currency defined based on a cryptocurrency of a blockchain.

Aspects of the present disclosure also provide a blockchain-based custom currency transaction system that provides a secure transaction service with regard to a custom currency, without a separate application for verifying transactions of the custom currency.

It should be noted that objects of the present disclosure are not limited to the above-described objects, and other objects of the present disclosure will be apparent to those skilled in the art from the following descriptions.

According to an aspect of the inventive concept, there is provided a blockchain-based custom currency transaction system comprising a plurality of blockchain nodes configured to establish a peer-to-peer (P2P)-based blockchain network, distribute and manage blockchain data in which a plurality of blocks are connected in a chain form, and record, using the blockchain data, transaction data of a custom currency defined based on a cryptocurrency and a service providing server configured to interwork with the blockchain network and provide a transaction service for the custom currency, wherein the transaction data comprises first information about a first currency amount of the custom currency to be transacted and second information about a second currency amount of the cryptocurrency to be transacted.

According to another aspect of the inventive concept, there is provided a blockchain-based point-type currency transaction system comprising a plurality of blockchain nodes configured to establish a peer-to-peer (P2P)-based blockchain network, distribute and manage blockchain data in which a plurality of blocks are connected in a chain form, issue a cryptocurrency using the blockchain data and a point-type currency defined based on the cryptocurrency, and record transaction data of the cryptocurrency and the point-type currency and a service providing server configured to interwork with the blockchain network and provide a transaction service for the point-type currency, wherein the point-type currency is stored in a designated electronic wallet until a charging request from a user terminal is processed, and data of the issuance of the point-type currency is recorded in the blockchain data.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a view for illustrating a structure of blockchain data to be referred to in some exemplary embodiments of the present disclosure;

FIG. 2 is a view for illustrating a transaction data structure for a cryptocurrency to be referred to in some exemplary embodiments of the present disclosure;

FIGS. 3 and 4 are views for illustrating an open asset protocol to be referred to in some exemplary embodiments of the present disclosure;

FIG. 5 is a view of a blockchain-based custom currency transaction system according to one exemplary embodiment of the present disclosure;

FIGS. 6A and 6B are views for illustrating a transaction data structure for a custom currency according to some exemplary embodiments of the present disclosure;

FIG. 7 is a flowchart of a transaction data verification method according to an exemplary embodiment of the present disclosure;

FIGS. 8 to 10 are views for illustrating examples of using a plurality of custom currencies according to an exemplary embodiment of the present disclosure;

FIG. 11 is a block diagram of a service providing server as one element of the blockchain-based custom currency transaction system;

FIG. 12 is a block diagram of a user terminal as one element of the blockchain-based custom currency transaction system;

FIGS. 13 and 14 are views for illustrating a point charging process among types of transactions performed in the custom currency transaction system according to an exemplary embodiment of the present disclosure;

FIGS. 15 and 16 are views for illustrating a point saving process among the types of transactions performed in the custom currency transaction system according to an exemplary embodiment of the present disclosure; and

FIGS. 17 and 18 are views for illustrating a point deduction process among the types of transactions performed in the custom currency transaction system according to an exemplary embodiment of the present disclosure.

### DETAILED DESCRIPTION OF THE EMBODIMENTS

Hereinafter, preferred embodiments of the present invention will be described with reference to the attached drawings. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like numbers refer to like elements throughout.

Unless otherwise defined, all terms including technical and scientific terms used herein have the same meaning as commonly understood by one of ordinary skill in the art to which this invention belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Prior to the description of this specification, some terms used in this specification will be defined.

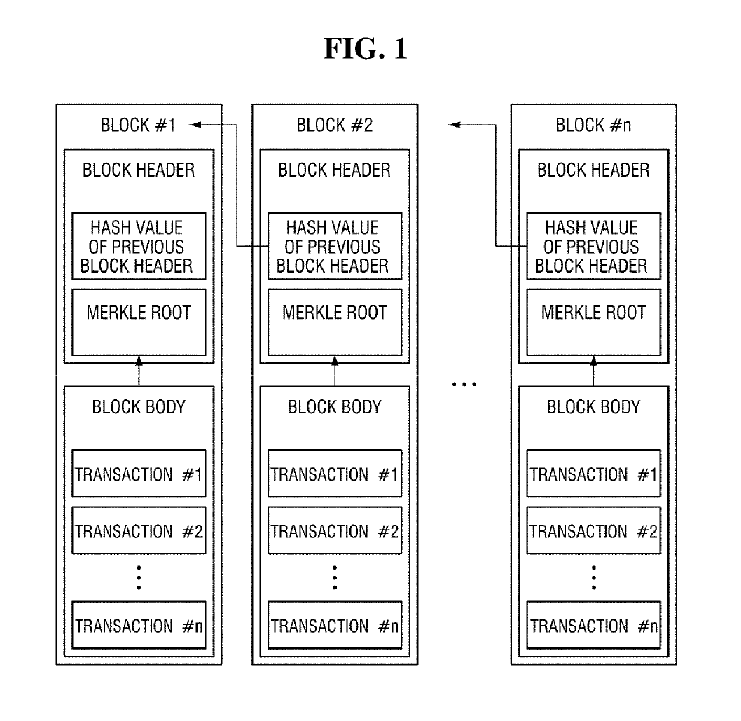

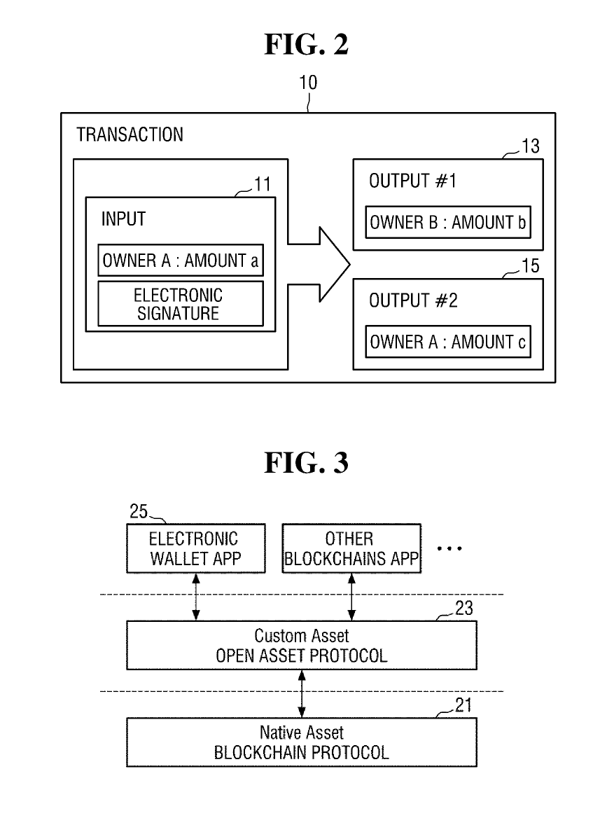

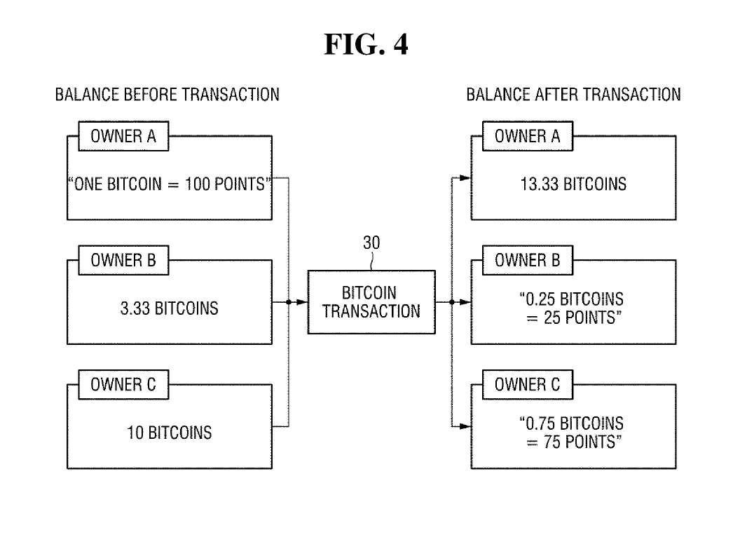

In this specification, blockchain data refers to data in which each individual blockchain node of a blockchain network is maintained, and indicates data in which at least one block is configured in a chain-form data structure. When data recorded in each individual block is transaction data, the blockchain data may be used as a distributed ledger. However, the kind of data to be recorded in each individual block may be varied as desired. The structure of the blockchain data is shown in FIG. 1.

In this specification, the blockchain network refers to a network of a peer-to-peer (P2P) structure having a plurality of blockchain nodes that operates in accordance with a blockchain algorithm.

In this specification, the blockchain node refers to that which forms the blockchain network and maintains and manages blockchain data on the basis of a blockchain algorithm. The blockchain node may be materialized as a single computing device, but may also be achieved using a virtual machine or the like. When the virtual machine is used as the blockchain node, a plurality of nodes may be present in the single computing device.

In this specification, a block mining node refers to a node for mining new blocks through mining among the blockchain nodes of the blockchain network.

In this specification, a cryptocurrency in a broad sense refers to an electronic currency to be transacted in cyberspace without real objects. In a narrow sense, the cryptocurrency refers to an electronic currency issued through mining in the blockchain, like bitcoins for example, and may be used along with the term ‘native asset’ or the like in the art.

In this specification, a custom currency refers to a currency defined by a user and based on the cryptocurrency. For example, the custom currency may be a currency defined by a transaction service operator through the open asset protocol. For reference, the term “currency” in the cryptocurrency and/or the custom currency may be used to have a comprehensive meaning, including an asset to be transacted as well as a currency to be used as a means of exchange. For example, the custom currency may include a financial asset such as a stock, a bond, etc. as well as a commodity currency, a point-type currency such as points, mileage, etc. The custom currency may be used along with the term ‘custom asset’ or the like in the art.

In this specification, the open asset protocol refers to the asset issue technology of issuing the custom currency based on the cryptocurrency in the blockchain. The open asset protocol may be used along with the term ‘colored coin’ or the like in the art.

In this specification, permission may be understood as a comprehensive concept including authentication and authorization.

Below, some exemplary embodiments of the present disclosure will be described in detail with reference to the accompanying drawings. Further, for convenience of understanding, some exemplary embodiments of the present disclosure will be described below on the assumption that the cryptocurrency is bitcoins, and the custom currency is a point (e.g., a membership point). However, the scope of the present disclosure is not limited to specific kinds of cryptocurrency or custom currency.

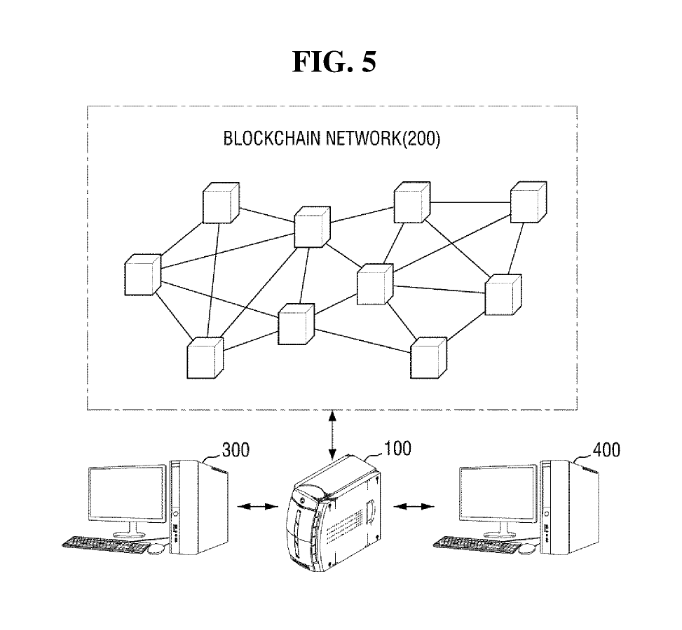

FIG. 5 is a view of a blockchain-based custom currency transaction system according to one exemplary embodiment of the present disclosure.

Referring to FIG. 5, the blockchain-based custom currency transaction system may be configured to include a service providing server 100, a blockchain network 200, and user terminals 300 and 400. However, this is merely an exemplary embodiment for achieving an object of the present disclosure, and some elements may be added or removed as necessary. Further, the elements of the custom currency transaction system shown in FIG. 5 indicate functional elements that are functionally classified, and it will be appreciated that at least one element may be given in combination form in a real physical environment.

For example, the service providing server 100 and the user terminals 300 and 400 may also be materialized as one blockchain node in the establishment of the blockchain network 200. Below, the elements of the custom currency transaction system will be described.

In the custom currency transaction system, the service providing server 100 is a computing device that provides a transaction service for the custom currency through the blockchain network 200. Here, the computing device may include a notebook computer, a desktop computer, a laptop computer, etc. without limitation, and may include any kind of devices including an operating unit and a communicating unit. However, to process a plurality of transaction requests, the service providing server 100 may be materialized as a server computing device of high performance.

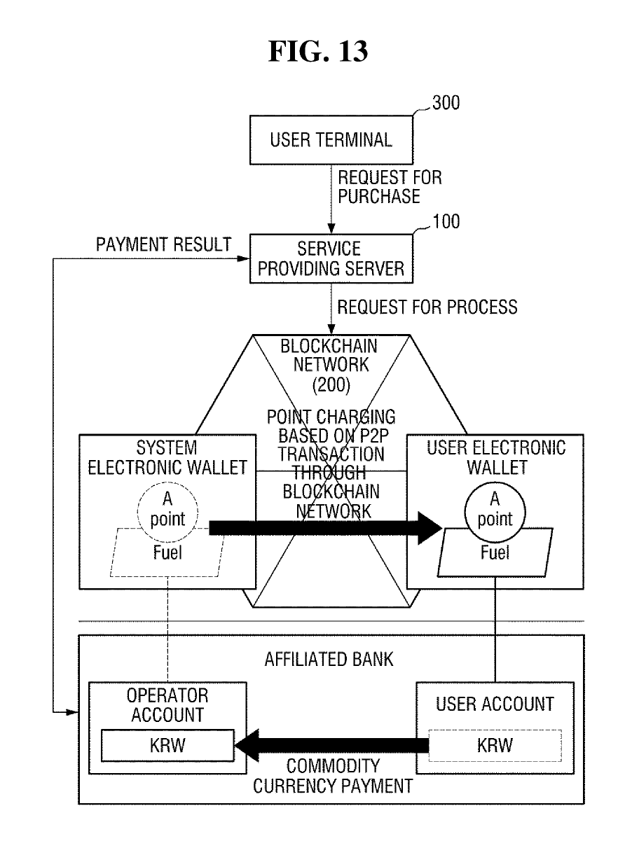

According to one exemplary embodiment of the present disclosure, the service providing server 100 provides, to a user, a transaction service including various transaction types such as purchasing points, savings points, withdrawing points, etc. In the embodiment, a user uses a commodity currency to purchase points, and withdraws the original commodity currency again from the purchased points. According to the exemplary embodiment, the custom currency interworks with the commodity currency, and is thus improved in utility and value. Further, a user may use the points as currency to purchase goods, thereby enhancing user convenience. Details of this exemplary embodiment will be described with reference to FIGS. 13 to 18.

In the custom currency transaction system, the blockchain network 200 is a network having a P2P structure established with a plurality of blockchain nodes. The blockchain nodes in the establishment of the blockchain network 200 perform mining, spreading, verifying, recording, and like operations with regard to blocks, based on the blockchain algorithm. Further, each individual blockchain node keeps the same blockchain data.

Each individual blockchain node verifies transaction validity of the cryptocurrency recorded together with transaction data in accordance with the blockchain algorithm (e.g., UTXO verification) whenever the transaction data recorded with the transaction history of the custom currency is received.

According to one embodiment of the present disclosure, when each individual blockchain node verifies transaction validity of the cryptocurrency, transaction validity of the custom currency may also be subjected to verification. For example, when the cryptocurrency is verified through UTXO verification in whether double spending has occurred, the custom currency may also be subjected to verification with regard to double spending. To this end, the blockchain network 200 according to the exemplary embodiment of the present disclosure may operate based on the following rules.

The first rule is that the cryptocurrency is used in a second currency amount when the custom currency is issued a first currency amount, and the value of the first currency amount is the same as the second currency amount. According to an exemplary embodiment, a predetermined first cryptocurrency used when a first custom currency is issued may be marked. The marking indicates that it was used in the issuance of the first custom currency. Thus, the marked first cryptocurrency may be transacted as well in the future when the first custom currency is transacted. However, according to an exemplary embodiment, a predetermined second cryptocurrency, but not the first cryptocurrency used in the issuing may be transacted as well when the first custom currency is transacted. For convenience of understanding, the following descriptions will be made on the assumption that the value of the custom currency is equal to the value of the cryptocurrency 1:1. That is, the descriptions will be made on the assumption that an issuance amount of the custom currency is equal to a currency amount of the cryptocurrency. In addition, in some exemplary embodiments of the present disclosure, that the first currency amount of the custom currency is equal to the second currency amount of the cryptocurrency means that the currency value of the first currency amount is equal to the currency value of the second currency amount.

According to the first rule, for example, a predetermined amount of Satoshi (cryptocurrency) may be previously issued, and 100 Satoshi among the previously issued Satoshi may be used to issue 100 points (custom currency). On the other hand, when 100 Satoshi is issued as the block mining node succeeds in mining, 100 points may also be issued. Here, the issued custom currency may be kept in a system electronic wallet of a transaction system. The system electronic wallet may be regarded as a place where the issued custom currency is kept before it is purchased by a user, and may be materialized in any way.

The second rule is that the transaction of the cryptocurrency is also processed when the transaction of the custom currency is processed. For example, when the transaction is processed to make a first user pay a second user 100 points, the transaction is also processed to make the first user pay the second user 100 Satoshi.

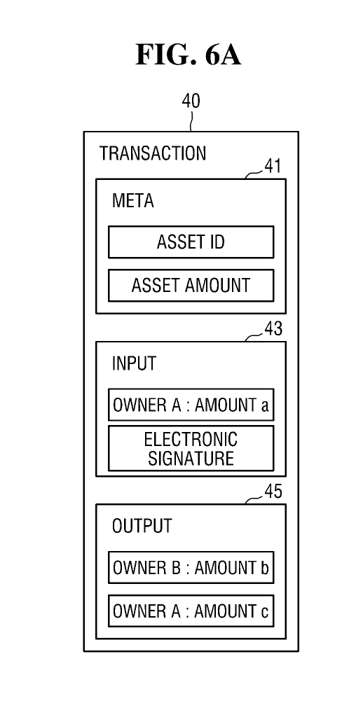

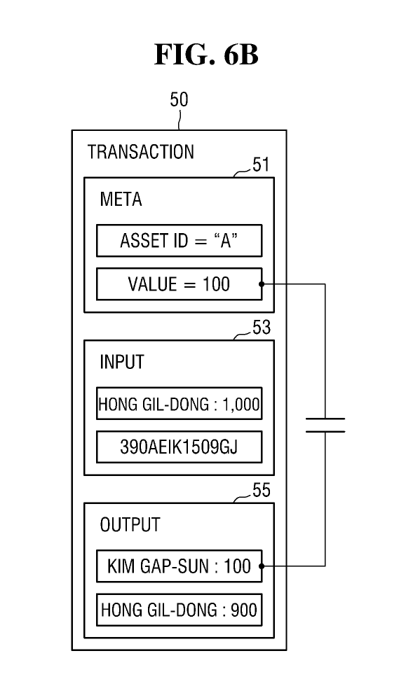

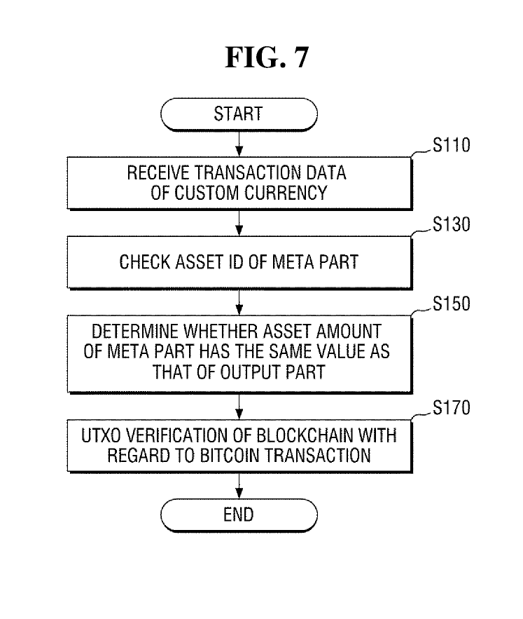

Through the first rule and the second rule, the blockchain network 200 operates to keep a total issued amount (or a total issued value) of custom currency equal to a total currency amount (or a total currency value) of cryptocurrency, and operates to make the custom currency and the cryptocurrency of the same currency amount (or currency value) always be subjected to the transaction together. Therefore, when transaction validity of the cryptocurrency is verified, transaction validity of the custom currency is also automatically verified. Details of a method of verifying the transaction of the custom currency on the blockchain network 200 will be described below with reference to FIGS. 6A to 7.

According to the exemplary embodiment of the present disclosure, the blockchain network 200 may be a permission-based blockchain network. That is, the blockchain network 200 may be a network established by participation of only permitted blockchain nodes. Here, the permission-based blockchain network may be used along with the term ‘private blockchain network’ or the like in the art, but may have the same meaning. According to the exemplary embodiment, since participation of unspecified nodes is not included, there is no need for excessive proof of operation required in mining the blocks, and it is possible to provide a safer transaction service.

In the foregoing exemplary embodiment, permission verification may be performed with regard to each of a user domain of a blockchain application service, a blockchain node domain, and a block mining node domain to establish a blockchain network based on permission. Below, the permission verification method performed in each domain will be described in brief.

In the case of the user domain of the blockchain application service, authentication and/or authorization management may be performed with regard to a service user. For example, access control is performed through an access control list (ACL) in an application program interface (API), or a user's electronic signature used in a transaction request is employed, thereby performing the permission verification with regard to the user.

In the case of the blockchain node domain, verification may be performed using permission information (e.g., permission information recorded in a configuration file) previously stored in each node at a time point when each blockchain node becomes activated to participate in the blockchain network. Here, the permission information may be periodically updated or controlled by a predetermined management device according to exemplary embodiments. Further, permission verification between the nodes may be performed in a stage in which each blockchain node sets up P2P communication with another blockchain node. In this case, the permission verification between the nodes may be performed using, for example, permission information stored in blockchain data (e.g., a whitelist including permitted blockchain node information, etc.). When the permission information is stored in the blockchain data, it is possible to prevent the permission information from being forged or altered. The permission information may be, for example, information set by a predetermined management device.

In the case of the block mining node domain, permission verification may be performed with regard to a new block. For example, each individual blockchain node may add only a new block, which is mined by the permitted block mining node, to blockchain data. At this time, the verification of the permission may be performed by the same method as the verification of the blockchain node domain. Further, when the block mining node generates a new block, its own electronic signature is forced to be recorded in the new block, and other blockchain nodes verify the electronic signature, thereby performing the permission verification with regard to the new block.

For reference, in the foregoing exemplary embodiments, the reliability of the blockchain network is largely influenced by whether the block mining node is well-intentioned or not, and therefore a second permission, i.e., a permission verification reference for the block mining node, is set to be higher than a first permission as a permission verification reference for the blockchain node.

In the custom currency transaction system, the user terminals 300 and 400 are terminals employed by users to use a transaction service provided by the service providing server 100. A user, who is one of people directly concerned with a transaction, may use the user terminal 300 or 400 to transact the custom currency stored in his/her own electronic wallet. For example, a user may use the user terminal 300 or 400 for transaction services such as savings points through payment with the commodity currency, purchasing predetermined goods with points stored in the electronic wallet, withdrawing the commodity currency from the stored points, etc. In this regard, details will be described below with reference to FIGS. 13 to 18.

For reference, according to this specification, in the case in which a user who employs a custom currency transaction service is an operator of a shop and a terminal of the user is employed for the shop, the terminal of the user may be referred to as a shop terminal. Hereinafter, when one of the people concerned with the transaction is the operator of the shop, it will be assumed that the user terminal 400 is used as the shop terminal.

In the custom currency transaction system, elements of the blockchain-based custom currency transaction system may communicate with each other through a network. Here, the network may be achieved by all kinds of wired/wireless networks such as a local area network (LAN), a wide area network (WAN), a mobile radio communication network, a wireless broadband internet (WiBro), etc.

The blockchain-based custom currency transaction system according to one exemplary embodiment of the present disclosure has been hitherto described with reference to FIG. 5. Next, a method of verifying the transaction data, which is performed in the custom currency transaction system, will be additionally described with reference to FIGS. 6A to 7. The verification method may be, for example, performed in each individual blockchain node in the establishment of the blockchain network 200.

FIGS. 6A and 6B are views for illustrating a transaction data structure for a custom currency based on bitcoins, and FIG. 7 is an exemplary flowchart of the transaction data verification method.

Referring to FIGS. 6A and 6B, transaction data 40 recorded in each block of the blockchain data includes a meta part 41, an input part 43, and an output part 45, and the meta part 41 includes ASSET ID indicating the kind of custom currency used in the transaction, and ASSET AMOUNT indicating a transaction amount of the custom currency. The input part 43 and the output part 45 include UTXO information about the bitcoins.

For more detailed example, in the case of a transaction 50 in which Hong Gil-dong (payer) pays Kim Gap-sun (payee) 100 points, a meta part 51 includes the information “100” related to a currency amount to be transacted, an input part 53 includes UTXO information of the bitcoins linked to the points Hong Gil-dong has, and an output part 55 includes UTXO information from a transaction result.

Then, as shown in FIGS. 6B and 7, a first verification operation S150 may be performed with regard to whether the currency amount information of points recorded in the meta part 51 matches the UTXO information, i.e., bitcoin currency amount information recorded in the output part 55 (that is, whether they have the same currency value), and a second verification operation S170 may be performed with regard to the UTXO information indicating bitcoins possessed amount of the payer. In addition, a third verification operation may be performed with regard to whether a total issued value of previously issued points is equal to a total value of bitcoins used in issuing the points. When the transaction validity is verified by the foregoing verification operations, whether double spending of the points has occurred may also be automatically verified. This is because the transaction of the cryptocurrency having the second currency amount of the same value as the first currency amount, while interworking with a transaction process of the custom currency having the first currency amount on the blockchain network 200, is processed based on the foregoing first and second rules.

Like this, based on whether or not the currency value of the custom currency to be transacted is equal to the currency value of the cryptocurrency to be transacted, it is possible to verify the transaction validity of the custom currency without any separate transaction verification application. In other words, the custom currency transaction system according to the embodiment of the present disclosure employs the key elements of the blockchain as they are, and therefore there is no need for adding a separate transaction verification application, thereby facilitating the expandability of the transaction service.

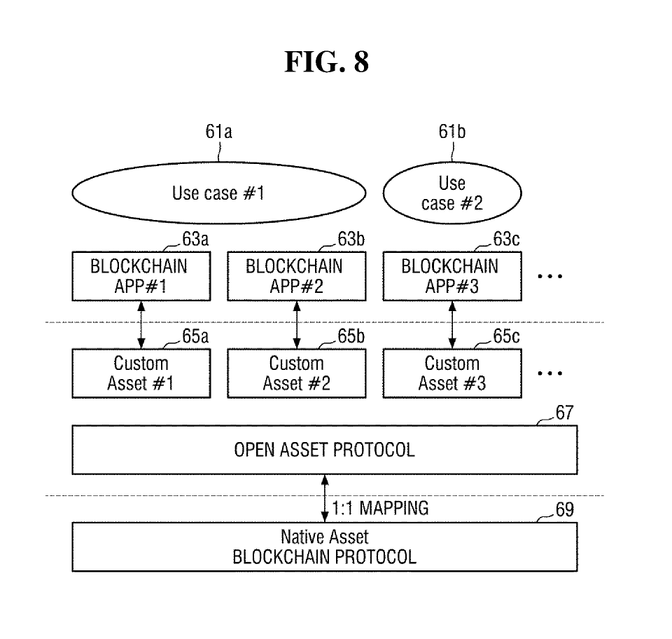

For example, the custom currency transaction system according to the embodiment of the present disclosure may provide a transaction service for a plurality of custom currencies without additional elements. In this regard, additional descriptions will be made with reference to FIGS. 8 to 10.

FIG. 8 is a view for illustrating an example of providing the transaction service for the plurality of custom currency defined in accordance with business use situations.

Referring to FIG. 8, a plurality of custom currencies 65a to 65c may be defined while interworking with the cryptocurrency (e.g., Bitcoin, Ethereum) on a blockchain 69 through an open asset protocol 67. For example, an operator of the transaction system may define the custom currencies 65a to 65c to designate different kinds of point such as charging points, reward points, marketing points, etc. or designate points according to location such as Korean points, U.S. points, Chinese points, etc. These may be defined in various forms by the operator in accordance with the business use situations 61a and 61b, and may also be defined in any form.

In the exemplary embodiment, when the custom currencies 65a to 65c are issued, the cryptocurrencies having the same values as the custom currencies 65a to 65c may be used. For example, when the custom currency has the same value as the cryptocurrency, the first custom currency is defined as Korean points and the second custom currency is defined as U.S. points, and up to an amount of 1,000 of the cryptocurrency may be used to issue the 1,000 Korean points and up to an amount of 100 of the cryptocurrency may be used to issue 100 U.S. points.

In other words, the service providing server 100 illustrated in FIG. 5 may be further configured to provide the transaction service for a plurality of custom currencies including a first custom currency (e.g. 65a) and a second custom currency (e.g. 65b). In this embodiment, in response to the first custom currency being issued in a first currency amount, the cryptocurrency may be used in a second currency amount. Further, in response to the second custom currency being issued in a second currency amount, the cryptocurrency may be used in a fourth currency amount. Further, the first currency amount is equal in value to the second currency amount, and the third currency amount is equal in value to the fourth currency amount.

According to the above-described embodiments, transaction verification is possible in accordance with blockchain protocols even through the types of custom currency become various and the unit value of each individual custom currency is varied depending on the expansion of the business use situation, thereby significantly improving the expandability of the system.

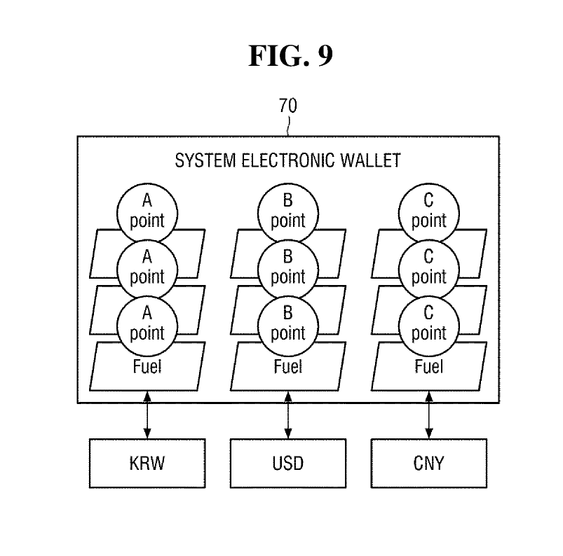

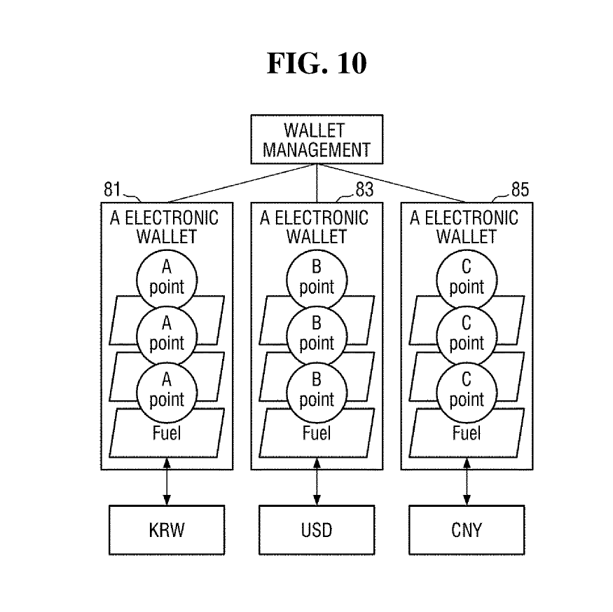

Meanwhile, as described above, the custom currency issued interworking with the cryptocurrency may be stored in the system electronic wallet until a customer makes a request for a purchase. When a plurality of custom currencies is defined, the system electronic wallet may be materialized as an electronic wallet 70 for integrated management of the plurality of custom currencies as shown in FIG. 9. Alternatively, as shown in FIG. 10, the system electronic wallet may be materialized as an electronic wallet for managing the custom currencies with separate electronic wallets 81 to 85.

According to an exemplary embodiment, when the custom currency is separately managed, the system electronic wallet may be materialized with a structure of a hierarchical deterministic wallet (HD-wallet). Such a case is advantageous since the electronic wallets may be easily granted different authorizations and roles in accordance with hierarchical relationships

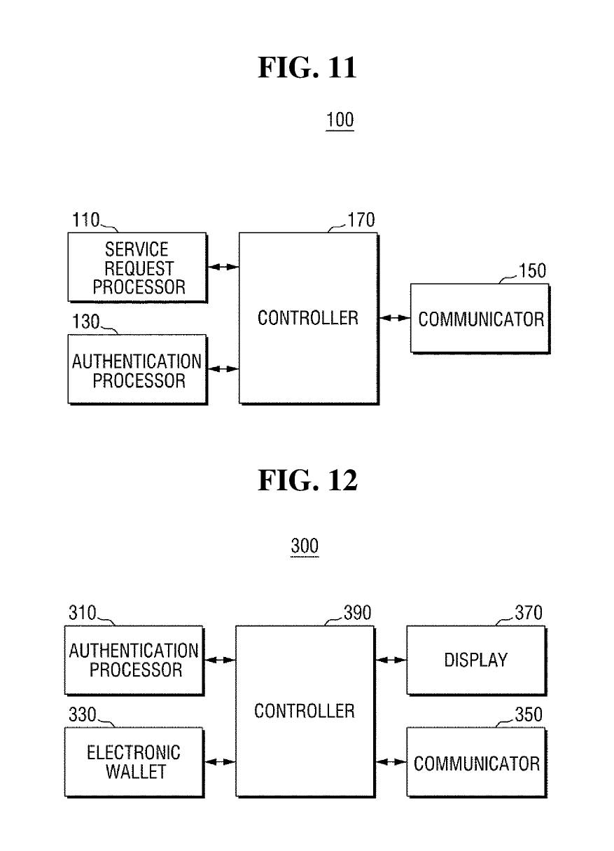

Examples of providing the transaction service to the plurality of custom currencies have been hitherto described with reference to FIGS. 8 to 10. Hereinafter, a configuration and operations of the elements in the blockchain-based custom currency transaction system according to one exemplary embodiment of the present disclosure will be described with reference to FIGS. 11 and 12.

FIG. 11 is a block diagram of a service providing server 100 as one element of the custom currency transaction system.

Referring to FIG. 11, the service providing server 100 may include a service request processor 110, an authentication processor 130, a communicator 150, and a controller 170. For reference, FIG. 11 shows only the elements related to the exemplary embodiment of the present disclosure. Therefore, those skilled in the art to which the present disclosure pertains will understand that other general-purpose elements may be provided in addition to the elements shown in FIG. 11. Further, the elements of the service providing server 100 shown in FIG. 11 indicate functional elements that are functionally classified, and it will be appreciated that at least one element may be given in combination form in a real physical environment.

The elements are as follows. The service request processor 110 processes various transaction requests for the custom currency, which are received from the user terminal 300 and/or the shop terminal 400, through the blockchain network 200. In this regard, detailed descriptions will be made below with reference to FIGS. 13 to 18.

The authentication processor 130 processes authentication-related general functions such as signing up for a membership, login, etc. of a user who uses the transaction service for the custom currency. A login method may be achieved using any method such as a password-based login, a certificate-based login, etc.

The communicator 150 provides a function of data communication with the elements of the custom currency transaction system. To this end, the communicator 150 may include a wired Internet module, a mobile communication module, or a wireless communication module.

The controller 170 controls general operations of the elements of the service providing server 100. The controller may be configured to include a central processing unit (CPU), a microprocessor unit (MPU), a microcontroller unit (MCU), or any processor well-known in the technical field of the present disclosure. Further, the controller may perform an operation for at least one application or program to implement the method according to the foregoing exemplary embodiments of the present disclosure.

By the way, although it is not illustrated in FIG. 11, the service providing server 100 may be configured to further include a storage (not shown). The storage (not shown) may be configured to non-temporarily store one or more computer programs for performing various operations of the service providing server 100, membership information, authentication information, etc. The storage (not shown) may include a nonvolatile memory such as a read only memory (ROM), an erasable programmable ROM (EPROM), an electrically erasable programmable ROM (EEPROM), a flash memory, etc., a hard disk drive, a detachable disk drive, or any computer-readable recording medium well-known in the technical field of the present disclosure.

Next, referring to FIG. 12, the user terminal 300 will be described as one element of the custom currency transaction system.

Referring to FIG. 12, the user terminal 300 may include an authentication processor 310, an electronic wallet 330, a communicator 350, a display 370, and a controller 390. For reference, FIG. 12 shows only the elements related to the embodiment of the present disclosure. Therefore, those skilled in the art to which the present disclosure pertains will understand that other general-purpose elements may be provided in addition to the elements shown in FIG. 12. Further, the elements of the user terminal 300 shown in FIG. 12 indicate functional elements that are functionally classified, and it will be appreciated that at least one element may be given in a combination form in a real physical environment.

The elements are as follows. The authentication processor 310 provides various authentication functions required in performing the custom currency transaction. For example, the authentication processor 310 processes a user's electronic signature, which is input when the transaction service is requested, by interworking with the service providing server 100.

The electronic wallet 330 is an applied blockchain that stores a user's own custom currency and/or cryptocurrency, and provides the transaction service to a user while interworking with the blockchain network 200 and/or the service providing server 100.

The communicator 350 provides a function of data communication with the elements of the custom currency transaction system. To this end, the communicator 350 may include a wired Internet module, a mobile communication module, or a wireless communication module.

The display 370 displays a transaction progress status, a barcode or quick response (QR) code used in transactions, etc. To this end, the display 370 may be configured to include a monitor, a touch screen, and like output devices.

The controller 390 controls general operations of the elements of the user terminal 300. The controller may be configured to include a CPU, a MPU, a MCU, or any processor well-known in the technical field of the present disclosure. Further, the controller may perform an operation for at least one application or program to implement the method according to the foregoing exemplary embodiments of the present disclosure.

Additionally, although it is not illustrated in FIG. 12, the user terminal 300 may be configured to further include an input part (not shown) and a storage (not shown).

The input part (not shown) receives various kinds of input from a user to perform the transaction service for the custom currency. To this end, the input part (not shown) may be configured to include a keyboard, a mouse, a touch screen, and like input devices.

The storage (not shown) may be configured to non-temporarily store one or more computer programs for performing various operations of the user terminal 300, membership information, authentication information, etc. The storage (not shown) may include a nonvolatile memory such as a ROM, an EPROM, an EEPROM, a flash memory, etc., a hard disk drive, a detachable disk drive, or any computer-readable recording medium well-known in the technical field of the present disclosure.

For reference, the shop terminal 400 may also be achieved using a configuration similar to that of the user terminal 300. However, the shop terminal 400 may be configured to include or exclude some elements as necessary in such a manner that the authentication processor 310 is excluded or the electronic wallet 330 is materialized as a shop electronic wallet and a reward electronic wallet.

The elements of the devices 100 and 300 described hitherto with reference to FIGS. 11 and 12 may mean software, or mean hardware such as a field programmable gate array (FPGA) or an application-specific integrated circuit (ASIC). However, the elements are not limited to software or hardware, but may be configured to be in a storage medium capable of addressing or executing one or more processors. The functions provided in the foregoing elements may be achieved with more subdivided elements, and may be achieved by one element in which a plurality of elements are combined to perform a specific function.

The configurations and operations of the service providing server 100 and the user terminal 300 in the blockchain-based custom currency transaction system have been hitherto described in brief with reference to FIGS. 11 and 12. Below, operations of processing various transaction types in the blockchain-based custom currency transaction system according to some exemplary embodiments of the present disclosure will be described with reference to FIGS. 13 to 18. For convenience of understanding, it will be assumed that the custom currency is a point.

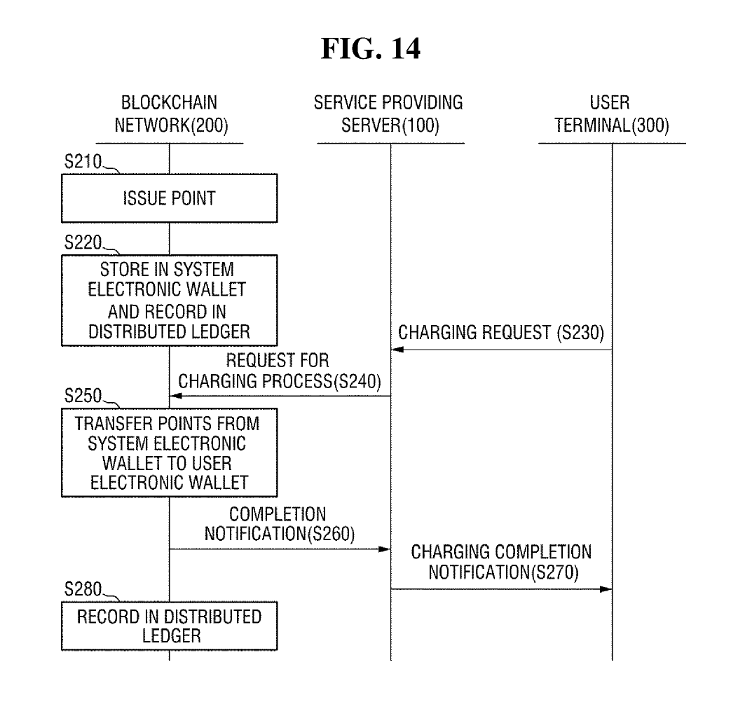

FIGS. 13 and 14 are views for illustrating a point charging process among types of transaction performed in the custom currency transaction system according to an exemplary embodiment of the present disclosure;

Charging (or purchasing) points refers to a transaction type in which a user pays a predetermined commodity currency to purchase as many points as a paid value from an operator.

Referring to FIG. 13, the service providing server 100 receives a point charging request from the user terminal 300, checks a real account transfer, payment with a credit card, or a like payment result, and processes, in accordance with the payment results, a predetermined amount of points to be transferred from the system electronic wallet to a user's electronic wallet through the blockchain network 200. In this regard, detailed processes are illustrated in FIG. 14.

Referring to FIG. 14, first, points are issued in the blockchain network 200, and the issued points are stored in the system electronic wallet (S210 and S220). For example, as the cryptocurrency is issued through the mining of the block mining node, the same amount of points as the cryptocurrency may also be issued. The issuance of the points is recorded in a distributed ledger of blockchain data.

Next, when the point charging request is received from the user terminal 300 (S230), the service providing server 100 makes a request for the point charging process to the blockchain network 200 (S240). Then, the blockchain node of the blockchain network 200 verifies and processes a transaction for transferring the points from the system electronic wallet to a user's electronic wallet, and records this transaction in a block (S250 and S280). When the requested transaction is processed, the service providing server 100 is informed of process completion (S260), and the service providing server 100 also informs the user terminal 300 of the point charging completion (S270).

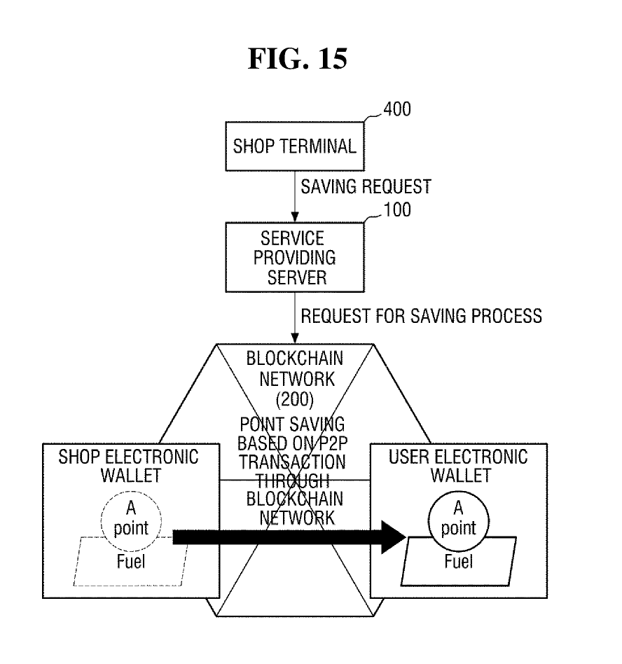

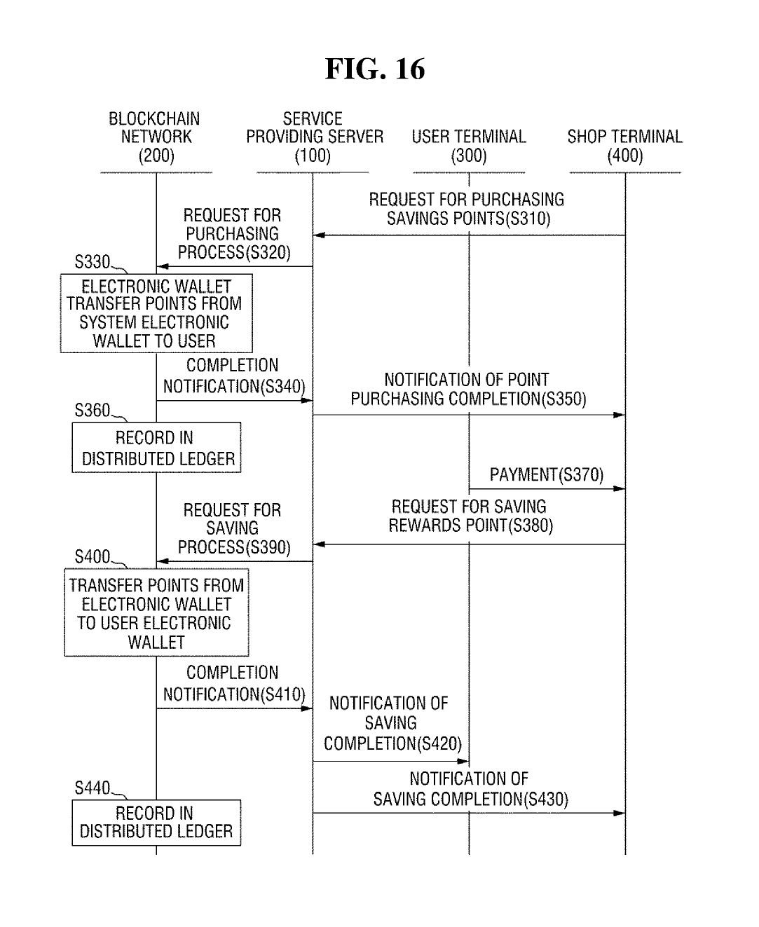

Next, a point saving process will be described with reference to FIGS. 15 and 16.

Savings points refer to a type of transaction in which a user is rewarded for purchasing goods and/or services with points. For example, saving the points may indicate a type of transaction in which as many points as a that of a predetermined percentage are saved as a user purchases goods using a commodity currency or points in an affiliated shop.

Referring to FIG. 15, the service providing server 100 receives the point saving request from the shop terminal 400, and processes a predetermined amount of points to be transferred from the shop electronic wallet to a user's electronic wallet through the blockchain network 200. The savings points stored in the shop electronic wallet may be points previously purchased by the operator of the shop. However, according to one exemplary embodiment, the operator of the shop may perform the point saving process in such a manner that the points stored in the system electronic wallet are transferred to the user electronic wallet, instead of previously making a purchase for the points.

According to an exemplary embodiment, the savings points may be defined as a separate custom currency different from general points. In this case, the shop terminal 400 may be configured to include the shop electronic wallet for storing the general points, and a reward electronic wallet for storing the savings points, and thus the savings points may be transferred from the reward electronic wallet to the user electronic wallet.

FIG. 16 illustrates a process in which the savings points purchased by the operator of the shop are saved in the user electronic wallet as a user makes a purchase for goods and/or services.

Referring to FIG. 16, first, in response to a request from the shop terminal 400 for purchasing the savings points, the process for purchasing the savings points is performed (S310 to S360). This process is similar to a user's process for purchasing the points, and thus repetitive descriptions will be avoided.

Next, when the shop terminal 400 receives payment information about goods and/or services from the user terminal 300 (S370), a point saving request is transmitted to the service providing server 100 (S380).

In response to the saving request, the service providing server 100 makes a request for the point saving process through the blockchain network 200 (S390), the savings points are transferred from the shop electronic wallet to the user electronic wallet (S400), and this transaction history is recorded in the distributed ledger to thereby completely save the points (S440).

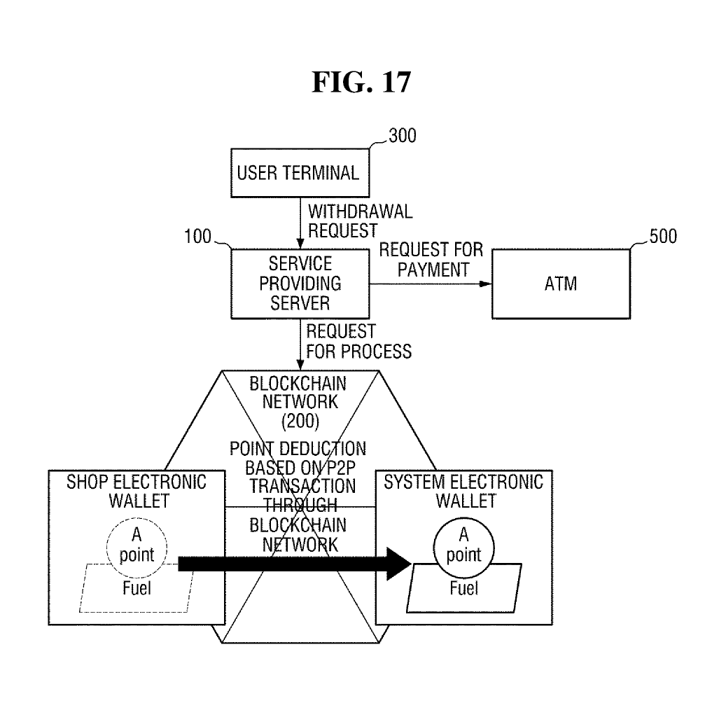

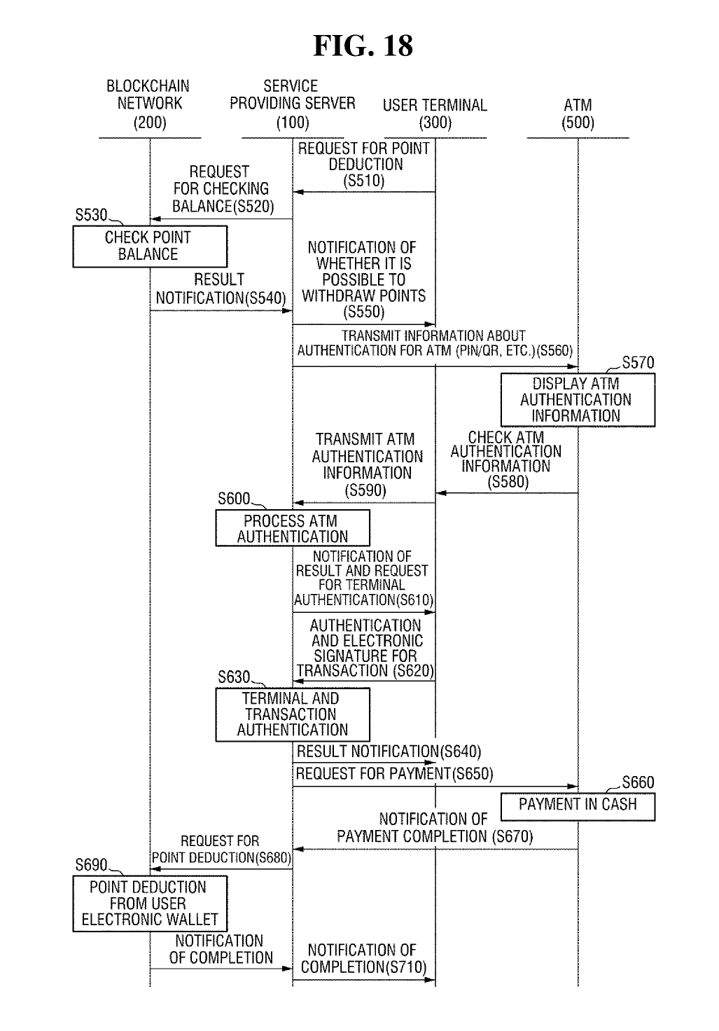

Next, a point deduction process will be described with reference to FIGS. 17 and 18.

Deducting points refers to a transaction type in which the points purchased by a user are converted back to the commodity currency. For example, through the point deduction, a user may get paid with the commodity currency for the previously purchased points through a commodity currency dispenser interworking with the service providing server 100. Below, it will be assumed that the commodity currency dispenser is an automatic teller machine (ATM).

Referring to FIG. 17, the service providing server 100 receives a point deduction request from the user terminal 300, transmits a payment request to an ATM 500, and makes a request for the point deduction process through the blockchain network 200. Related details are illustrated in FIG. 18.

Referring to FIG. 18, the service providing server 100, which receives the point deduction request from the user terminal 300, first checks a user's point balance through the blockchain network 200 (S510 to S540). Based on a result of checking the point balance, the service providing server 100 determines whether it is possible to withdraw the points, and informs the user terminal 300 of the determination result (S550). In the case that the points are withdrawable, the following processes are performed.

Next, the service providing server 100 performs authentication for the ATM 500 to pay a user with the commodity currency. For example, a user checks authentication information (e.g., a password or a QR code) transmitted from the service providing server 100 to the ATM 500, and the authentication information is transmitted to the service providing server 100 through the user terminal 300, thereby authenticating the ATM 500 (S560 to S600). However, a method of authenticating the ATM may be freely varied depending on the embodiment.

When the authentication for the ATM 500 is completed, the authentication for the user terminal 300 and the electronic signature for the deduction transaction may be processed (S610 to S630). The authentication for the user terminal may be performed in any way.

When the authentication for the user terminal 300 and the electronic signature for the deduction transaction are completely processed, the service providing server 100 transmits a payment request for the commodity currency to the ATM 500 (S650), and a user gets paid with the commodity currency from the ATM 500 for the deducted points (S660).

When informed of the payment process completion (S670), the service providing server 100 makes a request for processing the deduction transaction of a user's points through the blockchain network 200 (S680). For example, the point deduction may be performed in such a manner that the points are transferred from a user's electronic wallet to the system electronic wallet (S690). In more detail, the service providing server 100 makes a request for processing through the blockchain network 200 by the operation comprising a transferring operation and a recording operation. The transferring operation is an operation in which, among the points stored in the electronic wallet of the user, the points in an amount corresponding to the withdrawal request for the points are transferred to the system electronic wallet by a first blockchain node making up the blockchain network 200. And the recording operation is an operation in which the transaction data of the transferring operation is recorded in the blockchain data by a plurality of blockchain nodes.

Hitherto, the operations of processing various types of transaction in the blockchain-based custom currency transaction system according to some exemplary embodiments of the present disclosure have been described with reference to FIGS. 13 to 18.

As described above, the custom currency interworks with the commodity currency, and transaction services such as purchasing, saving, and withdrawing the custom currency are provided based on a blockchain. Therefore, the custom currency is improved in utility, and the transaction is performed through the blockchain, thereby guaranteeing the stability of the transaction services and improving the user convenience.

In the foregoing present disclosure, when the custom currency is issued in a first currency amount, cryptocurrency having the same value as the first currency amount is used. Further, whenever the custom currency is transacted, the cryptocurrency is also transacted together with the custom currency. Accordingly, when the blockchain's own function is implemented to perform validity verification (e.g., UTXO verification) for cryptocurrency transaction, the transaction validity of the custom currency is also automatically subject to verification.

Further, as the transaction for the custom currency is automatically verified, a safe transaction service is provided to a user without an additional verification application. Furthermore, it is possible to save manpower and time costs required in developing such a verification application

Further, since there is no need for an additional verification application, the blockchain-based transaction service is significantly improved in expandability and utility.

Further, the custom currency interworks with the commodity currency, and transaction services such as purchasing, saving, and withdrawing the custom currency are provided based on a blockchain. Therefore, the custom currency is improved in utility, and the transaction is performed through the blockchain, thereby guaranteeing the stability of the transaction services and improving user convenience.

The effects of the present disclosure are not limited to the foregoing effects, and other effects not mentioned above will also be clearly understood by those skilled in the art from the following descriptions.

The concepts of the invention described above with reference to FIGS. 5 to 18 can be embodied as computer-readable code on a computer-readable medium. The computer-readable medium may be, for example, a removable recording medium (a CD, a DVD, a Blu-ray disc, a USB storage device, or a removable hard disc) or a fixed recording medium (a ROM, a RAM, or a computer-embedded hard disc). The computer program recorded on the computer-readable recording medium may be transmitted to another computing apparatus via a network such as the Internet and installed in the computing apparatus. Hence, the computer program can be used in the computing apparatus.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

While the present invention has been particularly illustrated and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A blockchain-based custom currency transaction system comprising:
a plurality of blockchain nodes configured to establish a peer-to-peer (P2P)-based blockchain network, distribute and manage blockchain data in which a plurality of blocks are connected in a chain form, and record, using the blockchain data, transaction data of a custom currency defined based on a cryptocurrency; and
a service providing server configured to interwork with the blockchain network and provide a transaction service for the custom currency,
wherein the transaction data comprises first information about a first currency amount of the custom currency to be transacted and second information about a second currency amount of the cryptocurrency to be transacted.

2. The blockchain-based custom currency transaction system of claim 1, wherein, in response to the custom currency being issued in a third currency amount, the cryptocurrency is used in a fourth currency amount, and
wherein the third currency amount has an equal value to the fourth currency amount.

3. The blockchain-based custom currency transaction system of claim 1, wherein the custom currency is defined using an open asset protocol.

4. The blockchain-based custom currency transaction system of claim 1, wherein, in response to a first transaction for the custom currency being processed, a second transaction for the cryptocurrency is processed, and
wherein the first currency amount has an equal value to the second currency amount.

5. The blockchain-based custom currency transaction system of claim 1, wherein the transaction data is subject to verification by a first verification operation of verifying whether a first value of the first currency amount is equal to a second value of the second currency amount.

6. The blockchain-based custom currency transaction system of claim 5, wherein the transaction data is subject to verification by a second verification operation of further verifying whether a first total issued value of the custom currency previously issued is equal to a second total issued value of the cryptocurrency used in issuing the custom currency.

7. The blockchain-based custom currency transaction system of claim 5, wherein the transaction data further comprises information about a possessed currency amount of a payer who pays with the cryptocurrency, and
wherein the transaction data is subject to verification by a second verification operation in which at least one blockchain node among the plurality of blockchain nodes uses the blockchain data to further verify a value of the possessed currency amount.

8. The blockchain-based custom currency transaction system of claim 1, wherein the plurality of blockchain nodes comprises a block mining node that mines a new block to be added to the blockchain data,
wherein a preset amount of new cryptocurrency is issued in response to the new block being mined in the block mining node, and
wherein a new custom currency is issued, the new custom currency having an equal value to the new cryptocurrency in response to the issuance of the new cryptocurrency.

9. The blockchain-based custom currency transaction system of claim 1, wherein the custom currency comprises a first custom currency and a second custom currency,
wherein the service providing server is further configured to provide the transaction service for the first custom currency and the second custom currency,
in response to the first custom currency being issued in a third currency amount, the cryptocurrency is used in a fourth currency amount,
in response to the second custom currency being issued in a fifth currency amount, the cryptocurrency is used in a sixth currency amount,
wherein the third currency amount is equal in value to the fourth currency amount, and
wherein the fifth currency amount is equal in value to the sixth currency amount.

10. The blockchain-based custom currency transaction system of claim 9, wherein a previously issued first custom currency and a previously issued second custom currency are stored in a designated electronic wallet until a purchase request from a user terminal is processed, and
wherein the first custom currency is stored in a first electronic wallet, and the second custom currency is stored in a second electronic wallet different from the first electronic wallet.

11. The blockchain-based custom currency transaction system of claim 1, wherein the service providing server comprises a service request processor configured to process a purchase request for the custom currency through the blockchain network in response to the purchase request received from a user terminal, and
wherein the process for the purchase request is performed by a first blockchain node among the plurality of blockchain nodes, through a first processing operation in which a custom currency in an amount corresponding to the purchase request among previously issued custom currencies is transferred to an electronic wallet of a user in response to the purchase request received from the service request processor, and through a second processing operation in which the transaction data of the first processing operation is recorded in the blockchain data.

12. A blockchain-based point-type currency transaction system comprising:
a plurality of blockchain nodes configured to establish a peer-to-peer (P2P)-based blockchain network, distribute and manage blockchain data in which a plurality of blocks are connected in a chain form, issue a cryptocurrency using the blockchain data and a point-type currency defined based on the cryptocurrency, and record transaction data of the cryptocurrency and the point-type currency; and
a service providing server configured to interwork with the blockchain network and provide a transaction service for the point-type currency,
wherein the point-type currency is stored in a designated electronic wallet until a charging request from a user terminal is processed, and data of the issuance of the point-type currency is recorded in the blockchain data.

13. The blockchain-based point-type currency transaction system of claim 12, wherein the service providing server comprises a service request processor configured to check, in response to a purchase request for the point-type currency received from the user terminal, a payment result of a commodity currency for purchasing the point-type currency, and process the purchase request for the point-type currency through the blockchain network, and
wherein the process for the purchase request is performed by a first blockchain node among the plurality of blockchain nodes, through a first processing operation in which, among point-type currencies stored in the designated electronic wallet, a point-type currency in an amount corresponding to the purchase request is transferred to an electronic wallet of a user in response to the purchase request received from the service request processor, and through a second processing operation in which the transaction data of the first processing operation is recorded in the blockchain data.

14. The blockchain-based point-type currency transaction system of claim 12, wherein the service providing server comprises a service request processor configured to process a saving request for the point-type currency through the blockchain network in response to the saving request for the point-type currency received from a terminal of a shop and regarding a designated user as a payee, and
wherein the process for the saving request is performed by a first blockchain node among the plurality of blockchain nodes, through a first processing operation in which a point-type currency in an amount corresponding to the purchase request among point-type currencies stored in the electronic wallet of the shop is transferred to an electronic wallet of the designated user in response to the saving request received from the service request processor, and through a second processing operation in which the transaction data of the first processing operation is recorded in the blockchain data.

15. The blockchain-based point-type currency transaction system of claim 12, wherein, the service providing server comprises a service request processor configured to, in response to a withdrawal request for the point-type currency received from the user terminal, process the withdrawal request for the point-type currency through the blockchain network and a commodity currency dispenser, and
wherein the process for the withdrawal request comprises:
a first operation in which the service request processor checks a possessed amount of the point-type currency stored in the electronic wallet of a user through the blockchain network and determines whether the withdrawal request is processible,
a second operation in which the service request processor transmits a payment request for a commodity currency in an amount corresponding to the withdrawal request to the commodity currency dispenser when the withdrawal request is processible as a result of the determination, and receives a process result of the payment request, and
a third operation in which the service request processor makes a request for withdrawing the point-type currency such that the request is processed through the blockchain network, in response to the reception of the process result, and
wherein the third operation comprises a transferring operation in which, among the point-type currencies stored in the electronic wallet of the user, the point-type currency in an amount corresponding to the withdrawal request for the point-type currency is transferred to the designated electronic wallet by a first blockchain node among the plurality of blockchain nodes, in response to the withdrawal request received from the service request processor, and a recording operation in which the transaction data of the transferring operation is recorded in the blockchain data.

16. The blockchain-based point-type currency transaction system of claim 12, wherein the plurality of blockchain nodes comprises a block mining node that mines a new block to be added to the blockchain data,
wherein a preset amount of new cryptocurrency is issued in response to the new block being mined in the block mining node, and
wherein a new point-type currency is issued in an amount equal in value to the new cryptocurrency in response to the issuance of the new cryptocurrency, and the new issued point-type currency being stored in the designated electronic wallet.

17. The blockchain-based point-type currency transaction system of claim 12, wherein, in response to the point-type currency being issued in a first currency amount, the cryptocurrency is issued in a second currency amount,
wherein the first currency amount has an equal value to the second currency amount, and
wherein, in response to a first transaction for the point-type currency being processed, a second transaction for the cryptocurrency having an equal value to the point-type currency subject to the transaction is processed.
